(19) United States
(12) Patent Application Publication
(10) Pub. No.: US 2005/0073595 A1
(43) Pub. Date: Apr. 7, 2005

(54) Image capturing apparatus capable of being used as a mobile storage device

(75) Inventor: Wen Yen Huang, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/809,380

(22) Filed: Mar. 26, 2004

(30) Foreign Application Priority Data
Oct. 6, 2003 (TW) 092127656

(51) Int. Cl. H04N 5/76

(52) U.S. Cl. 348/231.99

(57) ABSTRACT

An image capturing apparatus employs an image sensing unit to use a optical lens module to sense external objects to obtain a corresponding digital image, then employs an image process controlling unit to receive the digital image to perform a digital image process to obtain a digital picture and stores the digital picture into a storage unit. The storage unit transmits the data in the storage unit to a host computer and the host computer uses the I/O unit to send the digital picture and data to the storage unit.

### BACKGROUND OF THE INVENTION

1. Field of the Invention

The present invention relates to an image capturing apparatus and, more particularly, to an image capturing apparatus capable of being used as a mobile storage device.

2. Description of the Related Art

With the continuing improvements in technology, the resolution of digital cameras is getting higher and higher. Additionally, as the system-on-chip design is the newest trend in IC designs, the size of digital cameras is getting smaller and smaller so that these devices can be carried around easily.

Furthermore, the current floppy disks are clearly insufficient for huge amounts of digital image data, which is inconvenient when traveling. Providing a digital camera that can storage digital data and send stored data to a computer device, or receive digital data from the computer device, would be of great convenience to the user.

Therefore, it is desirable to provide an image capturing apparatus to mitigate and/or obviate the aforementioned problems.

### SUMMARY OF THE INVENTION

A main objective of the present invention is to provide an image capturing apparatus, which can be used as both a digital camera and a storage device.

In order to achieve the above-mentioned objective, the image capturing apparatus capable of being used as a mobile storage device includes: an optical lens module; a storage unit for storing data; an image sensing unit for using the optical lens module to sense external objects to obtain a corresponding digital image; am image process controlling unit for receiving the digital image to perform a digital image process to obtain a digital picture and stores the digital picture into the storage unit; and an input/output (I/O) unit connected to the image process controlling unit for transmitting the data in the storage unit to a host computer, wherein the host computer can also transmit internally stored data to the storage via the I/O unit.

Other objectives, advantages, and novel features of the invention will become more apparent from the following detailed description when taken in conjunction with the accompanying drawings.

### BRIEF DESCRIPTION OF THE DRAWINGS

FIG. 1 is a functional block drawing of the present invention.

### DETAILED DESCRIPTION OF THE PREFERRED EMBODIMENT

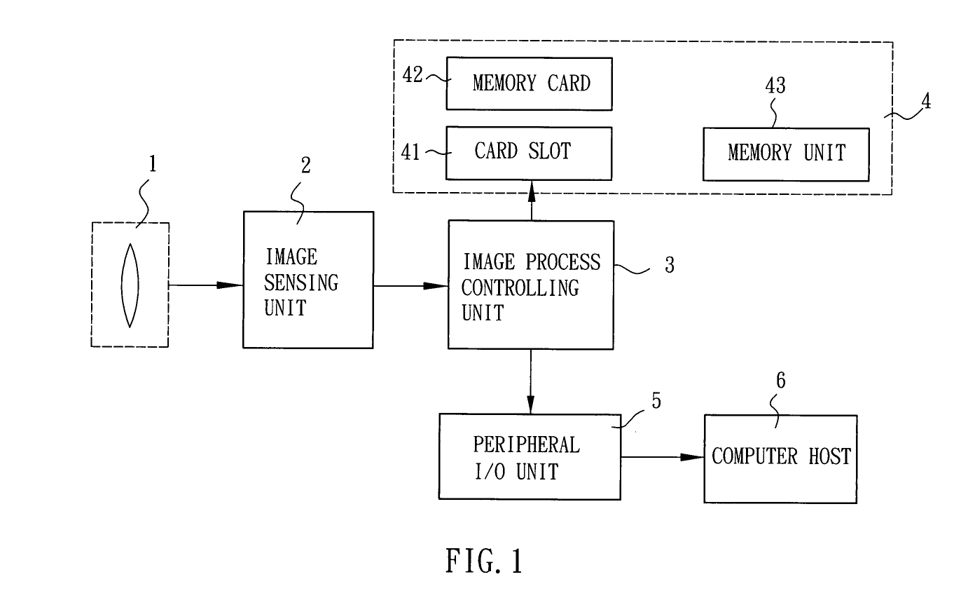

Please refer to FIG. 1. FIG. 1 is a functional block drawing of the present invention. An image capturing apparatus comprises an optical lens module 1, an image sensing unit 2, an image process controlling unit 3, a storage unit 4 and a peripheral input/output (I/O) unit 5. In this embodiment, the image sensing unit 2 is preferably a CCD (charge-coupled device) with millions of pixels.

The image sensing unit 2 uses the optical lens module 1 to sense external objects to obtain a corresponding digital image, and sends the sensed digital image to the image process controlling unit 3. The image process controlling unit 3 performs a digital image process upon the digital image to obtain a digital picture.

The image process controlling unit 3 stores the digital picture into the storage unit 4. In this embodiment, the storage unit 4 can be a plug-in memory card 42 inserted in a card slot 41, a built-in memory unit 43, or both. The plug-in memory card 42 can be any type of memory card, but is preferably a compact flash (CF) card, or a Memory Stick (MS or Secure Digital (SD)). The built-in memory unit 43 is flash memory.

The storage unit 4 is not just used for storing the digital picture but may also store digital data, such as a text file, a video file, etc. The data stored in the storage unit 4 can be transmitted to a computer host 6 via the I/O unit 5. In this embodiment, the I/O unit 5 is a universal serial bus (USB) device, and the computer host 6 is an electronic device with its own storage device, such as a personal computer or a PDA.

Moreover, the computer host 6 can transmit its stored data to the storage unit 4 via the I/O unit 5, so the image capturing apparatus of the present invention has bidirectional storage functionality. When the storage unit 4 is the built-in memory unit 43, if the memory space of the built-in memory unit 43 is insufficient for storing the data sent from the computer host 6, the plug-in memory card 42 can be added to expand the memory space of the storage unit 4.

According to above-mentioned description, the present invention uses the built-in memory unit or the plug-in memory card as the storage unit to store the digital pictures and data, and uses the I/O unit to send the stored digital picture and data to the host computer, or the host computer uses the I/O unit to send the digital picture and data to the present invention. Therefore, the image capturing apparatus of the present invention can be used as both a digital camera and a storage device.

Although the present invention has been explained in relation to its preferred embodiment, it is to be understood that many other possible modifications and variations can be made without departing from the spirit and scope of the invention as hereinafter claimed.

1. An image capturing apparatus capable of being used as a mobile storage device comprising:
an optical lens module;
a storage unit for storing data;
an image sensing unit for using the optical lens module to sense external objects to obtain a corresponding digital image;
am image process controlling unit for receiving the digital image to perform a digital image process to obtain a digital picture and stores the digital picture into the storage unit; and
an input/output (I/O) unit connected to the image process controlling unit for transmitting the data in the storage unit to a host, wherein the host can also transmit internally stored data to the storage via the I/O unit.

2. The image capturing apparatus as claimed in claim 1, wherein the I/O unit is a universal serial bus (USB).

3. The image capturing apparatus as claimed in claim 1, wherein the storage unit is a plug-in storage media unit.

4. The image capturing apparatus as claimed in claim 1, wherein the storage unit is a built-in storage media unit.

5. The image capturing apparatus as claimed in claim 1, wherein the storage includes a built-in storage media unit and a plug-in storage media unit.

6. The image capturing apparatus as claimed in claim 3, wherein the plug-in storage media unit is a compact flash (CF) card.

7. The image capturing apparatus as claimed in claim 3, wherein the plug-in storage media unit is a Memory Stick (MS) card.

8. The image capturing apparatus as claimed in claim 3, wherein the plug-in storage media unit is a secured digital (SD) card.

9. The image capturing apparatus as claimed in claim 4, wherein the built-in storage media unit is flash memory.

10. The image capturing apparatus as claimed in claim 1, wherein the host is a computer device.
